(19) United States
(12) Patent Application Publication
(10) Pub. No.: US 2026/0338105 A1
(43) Pub. Date: Oct. 29, 2026

(54) FLOW DIVIDING RING AND AERO ENGINE CONTAINING SAME, AND AIRCRAFT

(71) Applicant: AECC COMMERCIAL AIRCRAFT ENGINE CO., LTD., Shanghai (CN)

(72) Inventors: Jie SU, Shanghai (CN); Zhongtao HUANG, Shanghai (CN); Jieshan ZHANG, Shanghai (CN)

(73) Assignee: AECC COMMERCIAL AIRCRAFT ENGINE CO., LTD., Shanghai (CN)

(21) Appl. No.: 19/103,682

(22) PCT Filed: Aug. 25, 2023
(86) PCT No.: PCT/CN2023/114862

§ 371 Date: Feb. 13, 2025

(30) Foreign Application Priority Data
Aug. 29, 2022 (CN) 202211042953.5

(51) Int. Cl. F02C 7/047

(52) U.S. Cl. CPC F02C 7/047

(57) ABSTRACT

A flow dividing ring and an aero engine containing same, and an aircraft. In the flow dividing ring, an annular cavity is provided, and an air intake pipe supplies gas to the annular cavity. A flow guide member is arranged in the annular cavity, and one end of the flow guide member faces a circumferential direction of the annular cavity, and the other end of the flow guide member corresponds to a position where the air intake pipe is in communication with the annular cavity. Hot gas supplied by the air intake pipe to the annular cavity is enhanced by means of the flow guide member, so that the gas is distributed in all positions in the annular cavity, and then an inner wall of the annular cavity is heated by the gas, thereby increasing thermal efficiency of the flow dividing ring.

### TECHNICAL FIELD

The present disclosure relates to a flow dividing ring and an aero engine containing same, and an aircraft.

### BACKGROUND

Icing has a great impact on flight safety, especially for aero engines. Once icing occurs, it can cause poor air intake and reduce working efficiency of the engine in a minor case, and it can cause engine flameout or even physical damage, resulting in a severe safety accident in a severe case. As a physical element behind a fan for separating airflows of inner and outer ducts, an engine flow dividing ring is a typical anti-icing component, with a common anti-icing form of hot air anti-icing.

As the flow dividing ring has an annular cavity, when hot air enters the flow dividing ring cavity, there is inevitably a circumferential temperature drop caused by circumferential flow. In order to minimize an anti-icing bleed amount while an anti-icing effect is ensured, uniformity of heat distribution is a key technology in the design of a flow dividing ring anti-icing system.

For the uniformity of heat distribution, a current main technical means is multi-pipeline air supply. The main feature of this type of structure is that a high-pressure bleed pipe divides an original airflow into a plurality of circumferential airflows through a distribution pipe when approaching the flow dividing ring, and the plurality of airflows enter the flow dividing ring cavity along a corresponding number of circumferentially evenly distributed flow dividing pipes, to achieve the purpose of increasing thermal uniformity. The disadvantage of this structure is mainly that although the division into a plurality of flow dividing pipes for air intake can improve thermal uniformity, due to a weight limitation, there should not be excessive flow dividing pipes, which results in a large distance remaining between two adjacent flow dividing pipes. When the airflow in each flow dividing pipe rushes out of the pipe, the airflow mainly directly impacts on a cavity wall corresponding to a pipe opening, which results in a higher wall surface temperature here, but there is still a certain temperature difference at a wall surface away from the pipe opening, so that the airflow uniformity is poor, and cold air encountered during flight causes icing on a surface of the flow dividing ring with a lower temperature, thus affecting flight safety.

### SUMMARY OF THE DISCLOSURE

The technical problem to be solved by the present disclosure is to provide a flow dividing ring and an aero engine containing same, and an aircraft, in order to overcome the disadvantage in the prior art of poor fluidity of gas flowing into a flow dividing ring.

The present disclosure solves the above technical problem by the following technical solutions.

A flow dividing ring is provided. An annular cavity is provided in the flow dividing ring, and an air intake pipe is connected to the flow dividing ring and supplies gas to the annular cavity. The flow dividing ring further includes a flow guide member, where the flow guide member is arranged in the annular cavity, such that one end of the flow guide member in a flow guide direction of the gas faces a circumferential direction of the annular cavity, and the other end of the flow guide member in the flow guide direction of the gas corresponds to a position where the air intake pipe is in communication with the annular cavity.

In this solution, the flow guide member is arranged corresponding to the air intake pipe, and one end of the flow guide member extends in an axial direction of the annular cavity. The gas supplied by the air intake pipe flows to the flow guide member, and the gas flows in the circumferential direction of the annular cavity by the flow guide member, which improves uniformity of the gas flowing in the annular cavity. Moreover, when being high-temperature gas, the gas can heat an inner wall of the annular cavity that the gas flows across, and then the flow dividing ring is circumferentially uniformly heated, to remove ice formed on a peripheral side of the flow dividing ring by uniformly heating the flow dividing ring, thus ensuring flight safety of an airplane.

Preferably, the flow guide member is connected to the inner wall of the annular cavity.

In this solution, an end portion of the flow guide member extends in the circumferential direction in the annular cavity, and side portions of the flow guide member is connected to the inner walls of the annular cavity. That is, an upper inner wall and a lower inner wall of the annular cavity are connected by the flow guide member. The flow guide member can increase support points inside the annular cavity, thereby increasing structural strength of the flow dividing ring. On this basis, a wall surface of the flow dividing ring can be thinner, and an inner wall of the flow dividing ring can be heated by the high-temperature gas while the strength is ensured, thereby increasing a rate of melting the ice on the peripheral side of the flow dividing ring.

Preferably, a plurality of air intake pipes are provided in a circumferential direction of the flow dividing ring, and a plurality of flow guide members are provided in the annular cavity corresponding to the plurality of air intake pipes.

In this solution, the plurality of air intake pipes and the plurality of flow guide members are provided, with the purpose of ensuring that the gas flows in the circumferential direction in the annular cavity, to improve fluidity and uniformity of the gas, such that an air flow ring flowing in a radial direction of the flow dividing ring is formed when the gas flows in the annular cavity. This is a preferred structural configuration of the present application.

Preferably, the plurality of flow guide members are arranged in a circumferential direction of a middle part of the annular cavity.

In this solution, one end of the flow guide member extends in the radial direction of the flow dividing ring, such that the high-temperature gas flowing in from the air intake pipe flows in a radial direction of the annular cavity in the flow dividing ring. Further, the flow guide member is arranged at the middle part of the annular cavity, such that the high-temperature gas flows and circulates around the middle part of the annular cavity. During the circulation, the high-temperature gas may further spread to two sides of the annular cavity to increase the fluidity of the high-temperature gas, so that the high-temperature gas can circulate to all positions in the annular cavity, and the heating and deicing ability of the flow dividing ring is correspondingly improved, so as to ensure the flight safety of the airplane.

Preferably, a wall surface is provided in the annular cavity, is arranged away from the air intake pipe, and separates the annular cavity to form a front cavity and a rear cavity, the flow guide member is located in the rear cavity, a channel is provided in the wall surface, and the air intake pipe supplies the gas to the front cavity through the channel.

In this solution, the front cavity and the rear cavity are also provided in the annular cavity. The rear cavity is in communication with the air intake pipe, and the front cavity is in communication with the rear cavity via the channel. The air intake pipe supplies the high-temperature gas to the rear cavity. Part of the high-temperature gas flows to the front cavity through the channel. The inner wall of the front cavity is closer to cold air encountered during flight than the rear cavity, that is to say, the front cavity is also likely to encounter cold air and be iced, and thus deicing the front cavity by the supplied high-temperature gas is also very important.

Preferably, the front cavity has a tapered cross section, an exhaust port is provided in the inner wall of the front cavity, and the rear cavity is in communication with the exhaust port via the channel.

In this solution, the front cavity has a tapered cross section, with the purpose of better splitting the air, so as to reduce air resistance during flight. In addition, the front cavity increases thermal efficiency by means of impact and heat exchange. That is, the high-temperature gas impacts on the inner wall of the front cavity through the channel, to quickly increase the temperature of the inner wall of the front cavity and remove, by the front cavity with a increased temperature, the ice formed on a front edge part of the flow dividing ring by cold air. The high-temperature gas supplied to the front cavity is discharged through the exhaust port, to prevent the cooled high-temperature gas from still accumulating in the front cavity, which otherwise causes a peripheral side of the front cavity to be iced again. This is a preferred structural configuration of the present application.

Preferably, the channel is an air hole arranged in an axial direction of the flow dividing ring, the air hole corresponds to the inner wall of the front cavity, and the exhaust port and the air hole are located in different directions.

In this solution, the air hole is arranged in the axial direction of the flow dividing ring, and the air hole is in communication with the exhaust port. The high-temperature gas is supplied through the air hole. The exhaust port and the air hole are located in different directions, to prevent the high-temperature gas flowing into the front cavity from being discharged through the exhaust port without heating the inner wall of the front cavity, thereby prolonging the residence time of the high-temperature gas in the front cavity.

Preferably, a plurality of air holes are provided, and the exhaust port is arranged in a vertical direction and located on a bottom inner wall of the front cavity, and a plurality of exhaust ports are provided corresponding to the air holes.

In this solution, the plurality of air holes are provided to improve the impact of the high-temperature gas on the inner wall of the front cavity and increase thermal efficiency of heating and deicing the front cavity. In addition, the plurality of exhaust ports are also provided, to facilitate discharge of the cooled gas out of the front cavity through the exhaust ports after the high-temperature gas heats the inner wall of the front cavity and is cooled and before the thermal efficiency is reduced, so as to ensure that the front cavity can remain at a high temperature to remove the ice formed on the front edge of the flow dividing ring.

Preferably, the exhaust port is a through slot running through the inner wall of the front cavity, and the through slot is an annular through slot around a circumference of the flow dividing ring.

In this solution, the exhaust port may alternatively be a through slot, that is, the exhaust port is an annular through slot around the circumference of the flow dividing ring, so as to improve exhaust efficiency of the front cavity. Of course, the exhaust port may alternatively be of another structure, with the same purpose of discharging the cooled gas, so as to ensure that the front cavity remains at a high temperature to effectively remove the ice formed on the front edge of the flow dividing ring by cold air.

An aero engine includes a flow dividing ring according to any one of the above implementations.

In this solution, the aero engine with the above flow dividing ring has higher efficiency of removing ice formed by cold air being encountered around the engine, and circulation efficiency of the high-temperature gas in the front flow dividing ring of the engine is enhanced by the flow guide member, thereby improving thermal efficiency of the flow dividing ring and achieving a better deicing effect.

An aircraft includes an aero engine as described above.

The present disclosure has the following positive and progressive effects. According to the present disclosure, a circulating flow rate of gas, and in particular high-temperature gas supplied by the air intake pipe to the annular cavity of the flow dividing ring, is enhanced by means of the flow guide member, so that the high-temperature gas is distributed in all positions in the annular cavity, and then the inner wall of the annular cavity is heated by the high-temperature gas, thereby increasing thermal efficiency of the flow dividing ring, improving efficiency of the flow dividing ring heating and removing ice formed on the flow dividing ring when encountering cold air, and ensuring flight safety of the airplane.

### BRIEF DESCRIPTION OF THE DRAWINGS

FIG. 1 is a schematic diagram of an anti-icing system of an aero engine according to an embodiment of the present disclosure.

FIG. 2 is a schematic diagram of an operating state of a flow dividing ring according to an embodiment of the present disclosure.

FIG. 3 is a schematic diagram of a structure of a flow dividing ring according to an embodiment of the present disclosure.

FIG. 4 is a schematic diagram of an operating state of a flow guide member according to an embodiment of the present disclosure.

FIG. 5 is a perspective view of a flow guide member according to an embodiment of the present disclosure.

FIG. 6 is schematic diagram of gas flow in an annular cavity according to an embodiment of the present disclosure.

FIG. 7 is a side view of gas flow in an annular cavity according to an embodiment of the present disclosure.

### DESCRIPTION OF REFERENCE SIGNS

Nacelle 1
Flow dividing ring 2
Annular cavity 21
Wall surface 211
Channel 2111
Front cavity 212
Rear cavity 213
Flow guide member 22
Exhaust port 23
Support plate 3
High-pressure compressor 4
Combustion chamber 5
High-pressure turbine 6
Bleed device 7
Control valve 8
Air intake pipe 9

### DETAILED DESCRIPTION OF EMBODIMENTS

The present disclosure is further illustrated below by way of embodiments, but is not thus limited within the scope of the embodiments.

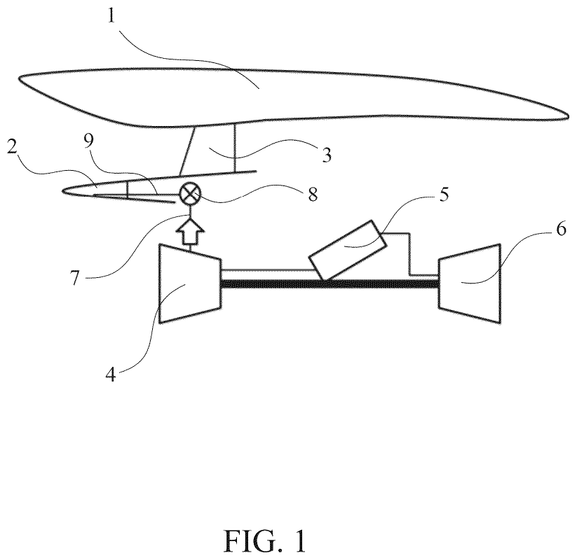

As shown in FIG. 1, an aero engine includes a core engine, a nacelle 1, and a flow dividing ring 2. The flow dividing ring is supported in the nacelle 1 by a support plate 3, and the flow dividing ring 2 is a physical element behind an engine fan for separating airflows of inner and outer ducts. The core engine includes a high-pressure compressor 4, a combustion chamber 5, and a high-pressure turbine 6. The high-pressure compressor 4 further compresses air and then discharges the air into the combustion chamber 5. Fuel oil and the air are mixed and then combusted, and then a fuel gas is discharged into the high-pressure turbine 6 to convert energy into mechanical energy. The temperature of the air compressed by the high-pressure compressor 4 may reach 600 °C. The air at the high-pressure compressor 4 is drawn out by a bleed device 7, reaches an air intake pipe 9 through a control valve 8 from the bleed device 7, and is sprayed into the flow dividing ring 2 through the air intake pipe 9.

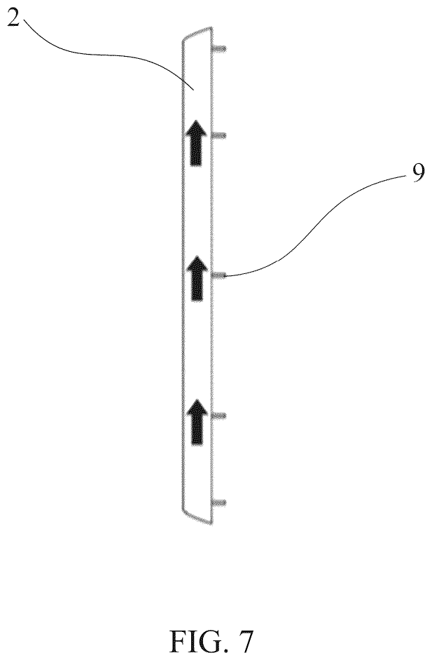

This embodiment provides a flow dividing ring, with a specific structure shown in FIGS. 3, 6 and 7. The flow dividing ring 2 is an annular member, and an annular cavity 21 is provided in the flow dividing ring 2. The air intake pipe 9 is connected to the flow dividing ring, and the air intake pipe 9 supplies gas into the annular cavity 21. The gas entering the annular cavity 21 can fill the annular cavity 21, and when the gas is compressed by the high-pressure compressor 4, the temperature of the gas can reach 600 °C, that is, high-temperature gas. The high-temperature gas fills the annular cavity 21 and is brought into contact with an inner wall of the annular cavity 21 to increase a surface temperature of the flow dividing ring 2. In this way, a surface of the flow dividing ring 2 is heated, so as to remove ice formed on the flow dividing ring 2 when the surface of the flow dividing ring 2 encounters cold air, for example, air containing water droplets or ice crystals, and to achieve an effect of deicing by hot air or heating and deicing and improve flight safety of an airplane.

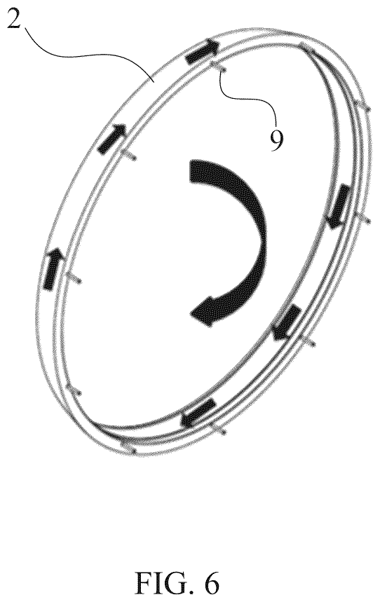

In addition, as shown in FIGS. 3 and 5, the flow dividing ring 2 further includes a flow guide member 22. The flow guide member 22 is arranged in the annular cavity 21, such that one end of the flow guide member 22 in a flow guide direction of the high-temperature gas faces a circumferential direction of the annular cavity 21, and the other end of the flow guide member 22 in the flow guide direction of the high-temperature gas corresponds to a position where the air intake pipe 9 is in communication with the annular cavity 21. An arc-shaped surface is formed between two ends of the flow guide member 22, and the arc-shaped surface is used to change the direction of an airflow flowing into the annular cavity 21. With regard to a curvature calculation formula for the arc-shaped surface, specifically, with a side close to the air intake pipe 9 as an inner wall surface, a curvature calculation formula for the inner wall surface is, y=0.0009898x³−0.06538x²+1.798x+0.16, and correspondingly, with a side away from the air intake pipe 9 as an outer wall surface, a curvature calculation formula for the outer wall surface is y=0.001195x³−0.08208x²+1.984x+3.044. That is to say, one end of the flow guide member 22 extends in the circumferential direction in the annular cavity 21, and the high-temperature gas is correspondingly sprayed on the arc-shaped surface of the flow guide member 22 after entering the annular cavity 21. The flow guide member 22 extends in the circumferential direction in the annular cavity 21 such that the high-temperature gas further flows around the annular cavity 21 in the annular cavity 21, thereby increasing a flow rate of the high-temperature gas, which causes a flow distance of the high-temperature gas in the annular cavity 21 to be greatly increased compared with a case in which the high-temperature gas is directly sprayed into the annular cavity 21. In addition, the high-temperature gas can heat a larger inner wall area of the annular cavity 21, which improves the thermal efficiency and thermal uniformity of the flow dividing ring 2, and shortens a time required for heating and deicing of the flow dividing ring 2. Flight safety of a high-speed flying airplane is more reliably ensured, thereby avoiding the problems such as damage to engine blades caused by ice falling into the engine fan.

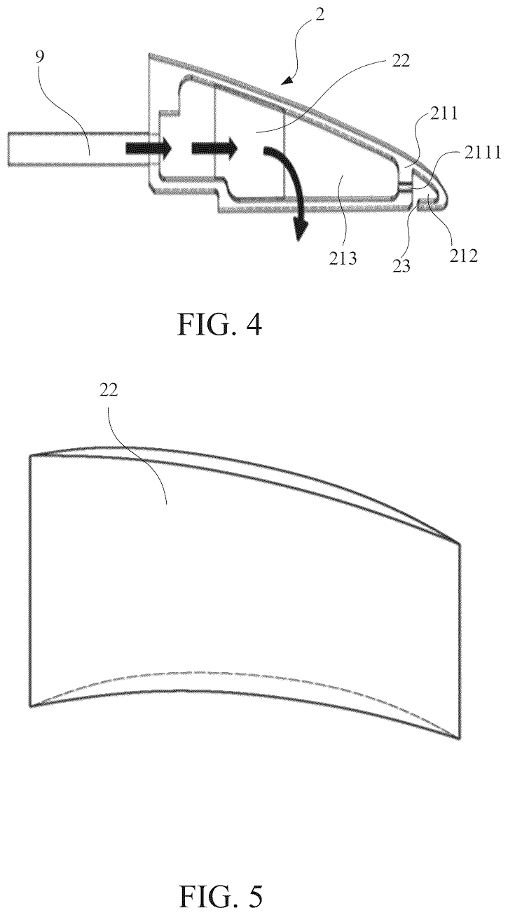

Further, as shown in FIGS. 3 and 4, an end portion of the flow guide member 22 extends in the circumferential direction in the annular cavity 21, and side portions of the flow guide member 22 are connected to an upper inner wall and a lower inner wall of the annular cavity 21. One of its purposes is to improve structural stability of the flow guide member 22, so as to prevent the flow guide member 22 from being dispersed due to the compressed high-temperature gas being sprayed too quickly into the annular cavity 21 through the air intake pipe 9, thus ensuring that the flow guide member 22 continuously and stably guides the high-temperature gas in the circumferential direction of the annular cavity 21. Another purpose is to connect the upper inner wall and the lower inner wall of the annular cavity 21 by the flow guide member 22. The flow guide member 22 can serve as a support point inside the annular cavity 21 to support the upper inner wall and the lower inner wall, with a function being equivalent to a support column or a support plate, to increase the structural strength of the flow dividing ring 2. On this basis, the thickness of the inner wall of the flow dividing ring 2 may be reduced more appropriately, and the inner wall of the flow dividing ring 2 can be heated by the high-temperature gas more quickly while the strength is ensured, thereby improving thermal efficiency and thermal uniformity of the flow dividing ring 2.

Preferably, one side of the flow guide member 22 is welded to the lower inner wall of the annular cavity 21, and the other side of the flow guide member 22 is in lap joint with the upper inner wall of the annular cavity 21, so as to ensure the structural stability of the flow guide member 22. During the process of changing the flow direction of high-temperature gas by the flow guide member 22, the temperature of the flow guide member increases as the high-temperature gas is sprayed on the flow guide member, since the flow guide member 22 is mostly made of a metal. In order to ensure the structural stability of the flow guide member 22, the flow guide member 22 and the inner wall of the annular cavity 21 of the flow dividing ring 2 are made of the same material to prevent the flow guide member 22 from being deformed after the flow guide member is heated by the high-temperature gas, thereby avoiding flight safety problems caused by local structural deformation of the flow dividing ring 2 when the flow dividing ring 2 is continuously supplied with the high-temperature gas through the air intake pipe 9 during high-speed flight.

As shown in FIGS. 4 and 6, in order to improve the thermal efficiency of the flow dividing ring 2, a plurality of air intake pipes 9 may be provided in a circumferential direction of the flow dividing ring 2, and a plurality of flow guide members 22 are provided in the annular cavity 21 corresponding to the plurality of air intake pipes 9. In this embodiment, 10 air intake pipes 9 are selected, and adjacent air intake pipes 9 are arranged spaced apart from each other, and the high-temperature gas is supplied into the annular cavity 21. There should not be excessive air intake pipes 9, so as to prevent an overweight structure of the flow dividing ring 2 from affecting the flight of the airplane. One end of each of the flow guide members 22 extends in the circumferential direction of the annular cavity 21, flow guide directions of the plurality of flow guide members 22 are the same, and the other end of each of the flow guide members 22 is in the same direction as an axial direction of the flow dividing ring 2, so that the high-temperature gas forms high-temperature gas in the annular cavity 21 that annularly flows, that is, annularly flows clockwise or annularly flows counterclockwise. The annularly flowing high-temperature gas has better fluidity and thermal uniformity.

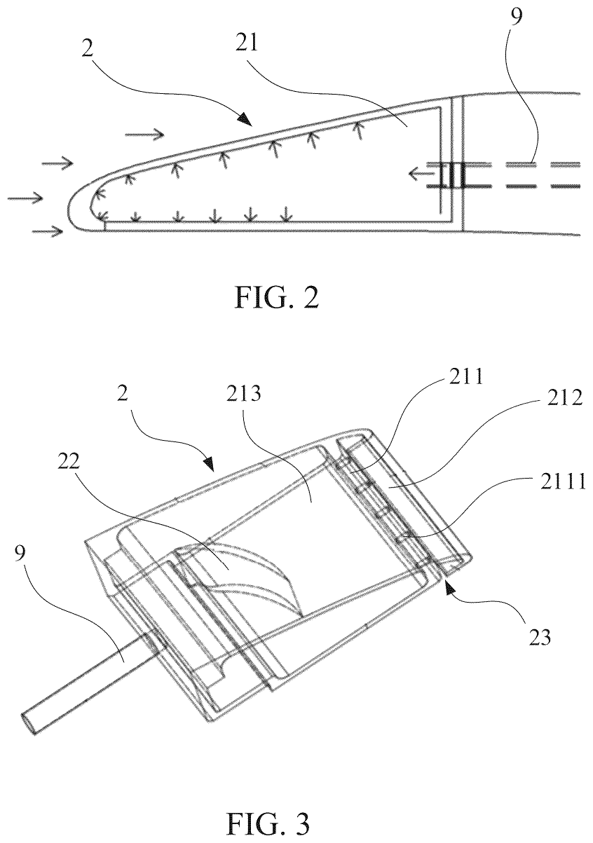

As shown in FIGS. 3 and 4, in this embodiment, a wall surface 211 is provided in the annular cavity 21, and the wall surface 211 is vertically arranged away from the air intake pipe 9. The wall surface 211 separates the annular cavity 21 to form a front cavity 212 and a rear cavity 213. The flow guide member 22 is located in the rear cavity 213, and the air intake pipe 9 is in communication with the rear cavity 213. A channel 2111 is provided in the wall surface 211 in a horizontal direction. The front cavity 212 is in communication with the rear cavity 213 via the channel 2111, and the air intake pipe 9 can supply the high-temperature gas to the front cavity 212 through the channel 2111. As shown in FIG. 2, the front cavity 212 corresponds to a front edge of an outer surface of the flow dividing ring 2, and the rear cavity 213 corresponds to a rear edge of the outer surface of the flow dividing ring 2. Increasing the flow rate of the high-temperature gas by the flow guide member 22 is mainly reflected in the heating of the rear edge, and the front cavity 212 is in communication with the rear cavity 213, so that the high-temperature gas flowing into the front cavity 212 through the channel 2111 is increased on the basis of increasing the flow rate of the high-temperature gas. Part of the high-temperature gas flows to the front cavity 212 through the channel 2111, so as to improve the thermal efficiency of the front cavity 212. The inner wall of the front cavity 212 is closer to cold air encountered during flight than the rear cavity 213, that is to say, the front cavity 212 is also likely to encounter cold air and be iced, and thus deicing the front cavity 212 by the supplied high-temperature gas is also a manner of improving the thermal efficiency of the flow dividing ring 2.

In addition, since the front cavity 212 encounters the cold air before the rear cavity 213, the cross section of the front cavity 212 is machined into a tapered shape, with the purpose of better splitting the air so as to reduce the air resistance during flight. In addition, an exhaust port 23 is provided in the inner wall of the front cavity 212, and the rear cavity 213 is in communication with the exhaust port 23 via the channel 2111. That is to say, the high-temperature gas supplied from the air intake pipe 9 to the rear cavity 213 flows into the front cavity 212 through the channel 2111, and the high-temperature gas flowing into the front cavity 212 is sprayed on the inner wall of the front cavity 212 to heat the inner wall of the front cavity 212. That is, the front cavity 212 increases the thermal efficiency of the flow dividing ring 2 by means of impact and heat exchange. After the high-temperature gas flowing into the front cavity 212 heats the inner wall of the front cavity 212, the temperature of the high-temperature gas itself is reduced. Since the high-temperature gas with a reduced temperature becomes slow to improve the thermal efficiency of the inner wall of the front cavity 212, which is not conducive to the heating and deicing of the flow dividing ring 2, the cooled high-temperature gas is discharged through the exhaust port 23, to speed up the efficiency of the high-temperature gas circulating into the front cavity 212. The high-temperature gas with a high temperature is reintroduced into the front cavity 212 through the channel 2111, so as to continuously heat and deice the front cavity 212, and prevent the front edge of the flow dividing ring 2 from icing again after the high-temperature gas is cooled.

Further, the channel 2111 is an air hole arranged in an axial direction of the flow dividing ring 2, and the air hole runs through the wall surface 211 and correspond to the inner wall of the front cavity 212, such that the high-temperature gas is directly sprayed to the inner wall of the front cavity 212 after entering the front cavity 212. The exhaust port 23 is arranged in a radial direction of the flow dividing ring 2 and is located on a bottom inner wall of the front cavity 212. The exhaust port 23 is not arranged corresponding to the air hole, to prevent the high-temperature gas flowing into the front cavity 212 from being discharged through the exhaust port 23 before the high-temperature gas heats the inner wall of the front cavity 212, thereby prolonging the residence time of the high-temperature gas in the front cavity 212 and improving the thermal efficiency of the flow dividing ring 2.

Of course, a plurality of air holes are provided, and a plurality of exhaust ports 23 are arranged corresponding to the air holes. The number of air holes is increased to increase an intake volume of the high-temperature gas impacting on the inner wall of the front cavity 212 and increase thermal efficiency of heating and deicing the front cavity 212. In addition, the plurality of exhaust ports 23 are also provided, to facilitate discharge of the cooled gas out of the front cavity 212 through the exhaust ports 23 after the high-temperature gas heats the inner wall of the front cavity 212 and is cooled and before the thermal efficiency is reduced, so as to ensure that the front cavity 212 can remain at a high temperature to remove the ice formed on the front edge of the flow dividing ring 2.

In a preferred implementation of this embodiment, the exhaust port 23 is a through slot running through the inner wall of the front cavity 212, and the through slot is an annular through slot around a circumference of the flow dividing ring 2, so as to improve exhaust efficiency of the front cavity 212, with the purpose of discharging the cooled high-temperature gas, so as to ensure that the front cavity 212 remains at a high temperature to effectively remove the ice formed on the front edge of the flow dividing ring 2 by cold air. Of course, the exhaust port 23 may alternatively be a circular hole or be of another structure, which is the prior art and is not described in detail here.

This embodiment further provides an aero engine, including the above flow dividing ring 2. The aero engine with the above flow dividing ring 2 has higher efficiency of removing ice formed by cold air being encountered around the engine, and circulation efficiency of the high-temperature gas in the front flow dividing ring 2 of the engine is enhanced by the flow guide member 22, thereby improving thermal efficiency and thermal uniformity of the flow dividing ring 2 and achieving a better deicing effect.

This embodiment further provides an aircraft, including the above aero engine. With the above aero engine, ice formed on the flow dividing ring 2 after encountering cold air can be quickly removed, and with the flow guide member 22, the fluidity of the high-temperature gas is improved, so as to improve the heating and deicing capacity of the flow dividing ring 2 at all positions, thus shortening the deicing time and ensuring flight safety of an aircraft or airplane.

Although specific implementations of the present disclosure have been described above, those skilled in the art should understand that these are merely examples, and the scope of protection of the present disclosure is defined by the appended claims. Those skilled in the art can make various changes or modifications to these implementations without departing from the principle and spirit of the present disclosure, but all the changes or modifications fall within the scope of protection of the present disclosure.

1-11. (canceled)

12. A flow dividing ring, an annular cavity being provided in the flow dividing ring, and an air intake pipe being connected to the flow dividing ring and supplying gas to the annular cavity, the flow dividing ring further comprising a flow guide member, wherein the flow guide member is arranged in the annular cavity, such that one end of the flow guide member in a flow guide direction of the gas faces a circumferential direction of the annular cavity, and the other end of the flow guide member in the flow guide direction of the gas corresponds to a position where the air intake pipe is in communication with the annular cavity.

13. The flow dividing ring according to claim 1, wherein the flow guide member is connected to an inner wall of the annular cavity.

14. The flow dividing ring according to claim 1, wherein a plurality of air intake pipes are provided in a circumferential direction of the flow dividing ring, and a plurality of flow guide members are provided in the annular cavity corresponding to the plurality of air intake pipes.

15. The flow dividing ring according to claim 3, wherein the plurality of flow guide members are arranged in a circumferential direction of a middle part of the annular cavity.

16. The flow dividing ring according to claim 1, wherein a wall surface is provided in the annular cavity, is arranged away from the air intake pipe, and separates the annular cavity to form a front cavity and a rear cavity, the flow guide member is located in the rear cavity, a channel is provided in the wall surface, and the air intake pipe supplies the gas to the front cavity through the channel.

17. The flow dividing ring according to claim 5, wherein the front cavity has a tapered cross section, an exhaust port is provided in an inner wall of the front cavity, and the rear cavity is in communication with the exhaust port via the channel.

18. The flow dividing ring according to claim 6, wherein the channel is an air hole arranged in an axial direction of the flow dividing ring, the air hole corresponds to the inner wall of the front cavity, and the exhaust port and the air hole are located in different directions.

19. The flow dividing ring according to claim 7, wherein a plurality of air holes are provided, and the exhaust port is arranged in a vertical direction and located on a bottom inner wall of the front cavity, and a plurality of exhaust ports are provided corresponding to the air holes.

20. The flow dividing ring according to claim 7, wherein the exhaust port is a through slot running through the inner wall of the front cavity, and the through slot is an annular through slot around a circumference of the flow dividing ring.

21. An aero engine, comprising a flow dividing ring according to claim 1.
